(19) United States
(12) Patent Application Publication
(10) Pub. No.: US 2008/0094132 A1
(43) Pub. Date: Apr. 24, 2008

(54) Semiconductor Intergrated Circuit

(76) Inventors: Takashi Kakemizu, Kyoto (JP); Yoshihiko Fukumoto, Kyoto (JP)

Correspondence Address: MCDERMOTT WILL & EMERY LLP, 600 13TH STREET, NW, WASHINGTON, DC, 20005-3096, US

(21) Appl. No.: 11/660,315

(22) PCT Filed: Feb. 14, 2006
(86) PCT No.: PCT/JP06/02521

§ 371 Date: Feb. 15, 2007

(30) Foreign Application Priority Data
Jun. 6, 2005 (JP) 2005-165407

(51) Int. Cl. G05F 1/00

(52) U.S. Cl. 327/545

(57) ABSTRACT

Between an analog circuit area 120 which includes circuits whose characteristics are degraded according to the level of noise contained in an input signal and a digital circuit area 130 which includes circuits that produce noise at such a level that the characteristics of the circuits in the analog circuit area 120 are caused to degrade, a digital circuit area 140 which only includes circuits that produce noise at such a level that the characteristics of the circuits in the analog circuit area 120 are not caused to degrade (or are caused to degrade within their acceptable limits) is located so as to prevent contact between the analog circuit area 120 and the digital circuit area 130.

### TECHNICAL FIELD

The present invention relates to a semiconductor integrated circuit in which circuits whose characteristics are degraded due to noise and circuits that produce the noise are both included.

### BACKGROUND ART

As today's semiconductor integrated circuits are called system-on-chips or system LSIs, many functions are integrated on a single semiconductor integrated circuit. In such a semiconductor integrated circuit, noise-sensitive analog circuits and digital circuits which produce noise that causes degradation of the characteristics of the analog circuits may be both included. In that case, it is necessary to prevent the noise produced from the digital circuits from propagating to the analog circuits, so as to avoid degradation of the characteristics of the analog circuits.

As a semiconductor integrated circuit having a structure for preventing propagation of noise produced from digital circuits to analog circuits, there has been a known semiconductor integrated circuit in which, for example, a guard band is provided between analog circuits and digital circuits to reduce noise propagation (see Patent Documents 1 and 2, for example).

FIG. 12 is a plan view illustrating the structure of a semiconductor integrated circuit 900 in which the above-described guard band is provided. FIG. 13 is a cross-sectional view (taken along the section line A-A of FIG. 12) of the semiconductor integrated circuit 900.

As shown in FIG. 12, the semiconductor integrated circuit 900 includes a semiconductor substrate 910, an analog circuit area 920, a digital circuit area 930, a guard band area 940, an analog circuit power source 950, and a digital circuit power source 960.

On the semiconductor substrate 910, analog circuits and digital circuits are both mounted.

The analog circuit area 920 is an area where the analog circuits are formed. The circuits in this area are sensitive to noise and the characteristics thereof are thus degraded by noise propagated through the power source and the like.

The digital circuit area 930 is an area including the digital circuits that produce noise at such a level that the characteristics of the circuits in the analog circuit area 920 are degraded.

The guard band area 940 includes substrate contacts 941, which are connected to the digital circuit power source 960.

The analog circuit power source 950 supplies power supply voltage to the circuits in the analog circuit area 920.

The digital circuit power source 960 supplies power supply voltage to the circuits in the digital circuit area 930.

In the semiconductor integrated circuit 900, the analog circuit area 920 and the digital circuit area 930 are on the semiconductor substrate 910, and the guard band area 940 is provided between the analog circuit area 920 and the digital circuit area 930.

In the semiconductor integrated circuit 900 thus structured, noise produced in the digital circuit area 930 passes through the guard band area 940 before propagating to the analog circuit area 920. At this time, as shown in FIG. 13, the noise passes through the substrate contacts 941 and the digital circuit power source 960 to go outside the semiconductor substrate 910. Specifically, the noise is absorbed in the guard band area 940 and is allowed to go outside the semiconductor substrate 910. Accordingly, the noise occurring in the digital circuit area 930 does not propagate to the analog circuit area 920, whereby it is possible to prevent degradation of the characteristics of the circuits in the analog circuit area 920.

Patent Document 1: Patent Publication No. 3075892

Patent Document 2: Japanese Laid-Open Publication No. 2002-246553

### DISCLOSURE OF THE INVENTION

### Problem that the Invention Intends to Solve

However, the above-described conventional semiconductor integrated circuit has a problem in that the guard band area is required as a physical area in the semiconductor integrated circuit, which results in increase in the area of the semiconductor integrated circuit. Furthermore, as the size of the guard band area is increased, the guard band area absorbs noise more effectively. Therefore, achieving more effective noise absorption requires more significant increase in the area of the semiconductor integrated circuit.

In view of the above problem, the present invention was made, and it is therefore an object of the present invention to provide a semiconductor integrated circuit in which although circuits (noise-sensitive circuits) whose characteristics are degraded due to noise and circuits that produce the noise are both included, the degradation of the characteristics of the noise-sensitive circuits is prevented without increasing the area of the semiconductor integrated circuit (the semiconductor substrate).

### Means for Solving the Problem

In order to solve the above problem, the first invention is a semiconductor integrated circuit including: a protected circuit area including circuits whose characteristics are degraded according to the level of noise; a high noise circuit area including circuits that produce noise at such a level that an amount of degradation caused in the circuits in the protected circuit area due to the noise exceeds an acceptable amount of degradation for the circuits in the protected circuit area; a low noise circuit area including circuits that produce noise at such a level that an amount of degradation caused in the circuits in the protected circuit area due to the noise is within the acceptable amount of degradation for the circuits in the protected circuit area; and three or more separate power sources whose paths for supplying power supply voltage are separate from each other, wherein the low noise circuit area is located between the protected circuit area and the high noise circuit area so as to prevent contact between the protected circuit area and the high noise circuit area; and the circuits in the protected circuit area, the circuits in the high noise circuit area, and the circuits in the low noise circuit area are supplied with power supply voltage by different power sources of the three or more separate power sources.

Then, noise produced in the high noise circuit area passes through the low noise circuit area to go outside the semiconductor substrate without propagating to the protected circuit area. The noise produced in the high noise circuit area thus does not propagate to the noise-sensitive protected circuit area. Accordingly, it is possible to prevent degradation of the characteristics of the circuits in the protected circuit area.

According to the second invention, in the semiconductor integrated circuit of the first invention, the circuits in the high noise circuit area and the circuits in the low noise circuit area produce noise at levels corresponding to the levels of the frequencies of signals handled by these circuits, and the maximum frequency of the signals handled in the low noise circuit area is lower than the frequencies of the signals handled in the high noise circuit area.

Then, the high noise circuit area and the low noise circuit area are formed based on the frequencies of the signals handled by the circuits therein.

According to the third invention, in the semiconductor integrated circuit of the first invention, the circuits in the protected circuit area are analog circuits, and the circuits in the high noise circuit area are digital circuits.

According to the fourth invention, in the semiconductor integrated circuit of the second invention, the circuits in the protected circuit area are analog circuits, and the circuits in the high noise circuit area are digital circuits.

Then, where analog circuits and digital circuits are both mounted on a single semiconductor substrate, the analog circuits whose characteristics easily degrade due to noise are protected from noise from the noise-source digital circuits.

### EFFECTS OF THE INVENTION

According to the present invention, it is possible to prevent the characteristics of circuits from degrading due to noise, without increasing the area of the semiconductor integrated circuit.

### BRIEF DESCRIPTION OF DRAWINGS

FIG. 1 is a plan view illustrating the structure of a semiconductor integrated circuit according to a first embodiment of the present invention.

FIG. 2 is a cross-sectional view of the semiconductor integrated circuit according to the first embodiment of the present invention.

FIG. 3 is a plan view illustrating the structure of a semiconductor integrated circuit according to a second embodiment of the present invention.

FIG. 4 is a plan view illustrating a modified example of the semiconductor integrated circuit according to the second embodiment of the present invention.

FIG. 5 is a plan view illustrating the structure of a semiconductor integrated circuit according to a third embodiment of the present invention.

FIG. 6 is a view illustrating connection relation between a semiconductor substrate and lead frames.

FIG. 7 is a plan view illustrating the structure of a semiconductor integrated circuit according to a fourth embodiment of the present invention.

FIG. 8 is a plan view illustrating a modified example of the semiconductor integrated circuit according to the fourth embodiment of the present invention.

FIG. 9 is a plan view illustrating another modified example of the semiconductor integrated circuit according to the fourth embodiment of the present invention.

FIG. 10 indicates spectral distributions of noise produced in digital circuit areas and a spectral distribution of signals handled in an analog circuit area.

FIG. 11 is a plan view illustrating an example in which a guard band area is added to the semiconductor integrated circuit according to the first embodiment of the present invention.

FIG. 12 is a plan view illustrating the structure of a conventional semiconductor integrated circuit.

FIG. 13 is a cross-sectional view of the conventional semiconductor integrated circuit.

### EXPLANATION OF THE REFERENCE CHARACTERS

100 Semiconductor integrated circuit
110 Semiconductor substrate
120 Analog circuit area
130 Digital circuit area
140 Digital circuit area
151 to 153 Power sources
160 Lead frame
170 Bonding wire
180 Bonding pad
200 Semiconductor integrated circuit
220 Analog circuit area
230 Analog circuit area
240 Analog circuit area
300 Semiconductor integrated circuit
320 Digital circuit area
330 Digital circuit area
340 Digital circuit area
400 Semiconductor integrated circuit
451 to 455 Power sources
500 Semiconductor integrated circuit
520 Analog circuit area
531 to 532 Digital circuit areas
541 to 542 Digital circuit areas
591 to 592 Wires
600 Semiconductor integrated circuit
621 to 623 Analog circuit areas
630 Digital circuit area
641 to 642 Digital circuit areas
690 Wire
700 Semiconductor integrated circuit
721 to 722 Analog circuit areas
730 Digital circuit area
741 to 742 Digital circuit areas
800 Semiconductor integrated circuit
860 Guard band area
900 Semiconductor integrated circuit
910 Semiconductor substrate
920 Analog circuit area
930 Digital circuit area
940 Guard band area
941 Substrate contact
950 Analog circuit power source
960 Digital circuit power source

### BEST MODE FOR CARRYING OUT THE INVENTION

Hereinafter, embodiments of the present invention will be described with reference to the accompanying drawings.

### First Embodiment

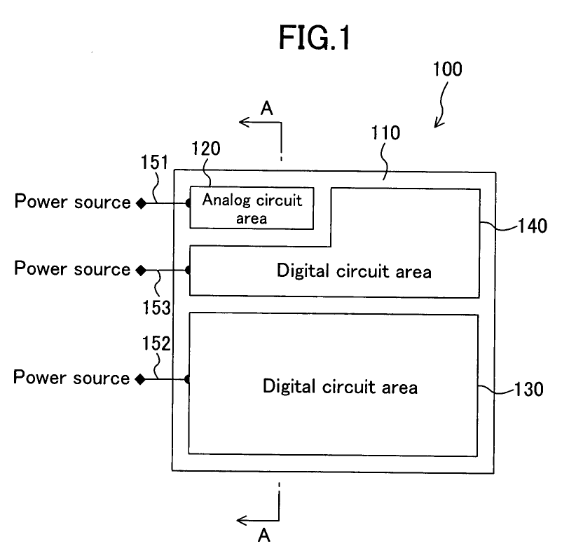

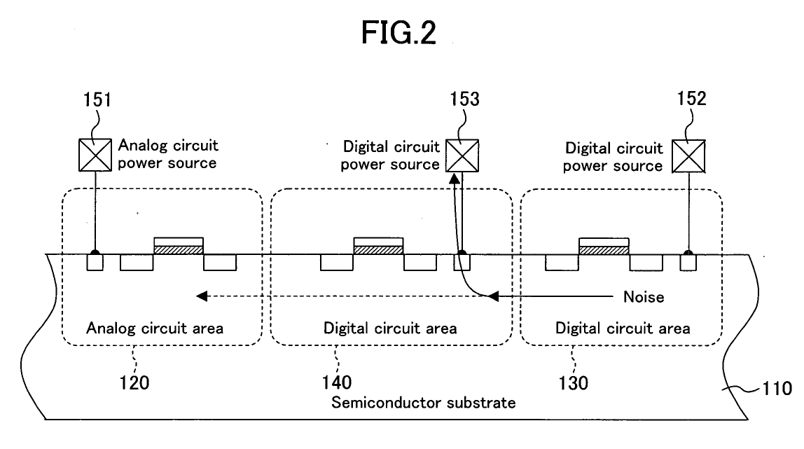

FIG. 1 is a plan view illustrating the structure of a semiconductor integrated circuit 100 according to a first embodiment of the present invention. FIG. 2 is a cross-sectional view (taken along the like A-A of FIG. 1) of the semiconductor integrated circuit 100. As shown in FIG. 1, the semiconductor integrated circuit 100 includes a semiconductor substrate 110, an analog circuit area 120, a digital circuit area 130, a digital circuit area 140, and power sources 151 to 153.

On the semiconductor substrate 110, analog semiconductor integrated circuits (analog circuits) and digital semiconductor integrated circuits (digital circuits) are both mounted.

The analog circuit area 120 is an area where the analog circuits are formed. Specific examples of the analog circuits formed in the analog circuit area 120 include a tuner, an AD converter, a DA converter, a PLL (a phase locked loop), a VCO (a voltage controlled oscillator), a filter, and an operational amplifier. These circuits are generally sensitive to noise, and the characteristics thereof are thus degraded according to the level of noise contained in a handled signal and the level of noise propagated thereto through the semiconductor substrate. Therefore, the analog circuit area 120 is an area (a protected circuit area) which should be protected from propagation of noise produced in the other circuit areas.

The digital circuit area 130 is an area (a high noise circuit area) including circuits that produce noise at such a level that the characteristics of the circuits in the protected circuit area are caused to degrade beyond their acceptable limits. In this embodiment, the digital circuit area 130 is an area including digital circuits that produce noise at a level corresponding to the operating frequency thereof. The operating frequency of the circuits in the digital circuit area 130 is 60 MHz.

The digital circuit area 140 is an area (a low noise circuit area) only including circuits that produce noise at such a level that the characteristics of the circuits in the protected circuit area are not caused to degrade (or are caused to degrade within the acceptable limits thereof). The digital circuit area 140 is also an area including digital circuits that produce noise at a level corresponding to the operating frequency thereof. The operating frequency of the circuits in the digital circuit area 140 is 10 MHz. That is, the operating frequency of the circuits in the digital circuit area 130 is higher than that of the circuits in the digital circuit area 140, and the level of noise produced in the digital circuit area 130 is thus higher than that in the digital circuit area 140.

As shown in FIG. 1, the analog circuit area 120, the digital circuit area 130, and the digital circuit area 140 are arranged in such a manner that the digital circuit area 140 is physically located between the analog circuit area 120 and the digital circuit area 130 so as to prevent contact between the analog circuit area 120 and the digital circuit area 130.

The power source 151 supplies power to the analog circuit area 120, the power source 152 supplies power to the digital circuit area 130, and the power source 153 supplies power to the digital circuit area 140. The power sources 151 to 153 are separate power sources that are not connected with each other, and the power supply paths thereof are thus separate from each other.

Once the semiconductor integrated circuit 100 is operated, noise is produced in the digital circuit areas 140 and 130. The noise produced in the digital circuit area 130 tends to propagate through the semiconductor substrate 110 toward the noise-sensitive analog circuit area 120.

However, the noise produced in the digital circuit area 130 passes through the digital circuit area 140 before propagation to the analog circuit area 120. At this time, as shown in FIG. 2, the noise produced in the digital circuit area 130 passes through the power source 153 for supplying the digital circuit area 140 with power supply voltage and goes outside the semiconductor substrate 110 without propagating to the analog circuit area 120. That is, the noise produced in the digital circuit area 130 does not propagate to the noise-sensitive analog circuit area 120.

Accordingly, in this embodiment, the noise occurring in the high noise circuit area does not propagate to the protected circuit area, whereby it is possible to prevent degradation of the characteristics of the circuits in the protected circuit area.

In addition, no guard band area is necessary, which allows the semiconductor substrate to be reduced in area. Furthermore, the low noise circuit area (the digital circuit area 140) is typically larger in area than a guard band area, and thus provides more effective noise absorption.

It should be noted that the operating frequencies in the digital circuit areas 140 and 130 are just examples, and are thus not limited to the values mentioned above.

### Second Embodiment

The type of circuits (i.e., analog circuits or digital circuits) included in each area such as the protected circuit area is not limited to the example described in the first embodiment.

A semiconductor integrated circuit according to a second embodiment is an example in which the type of circuits included in each area such as the protected circuit area is different from that in the first embodiment.

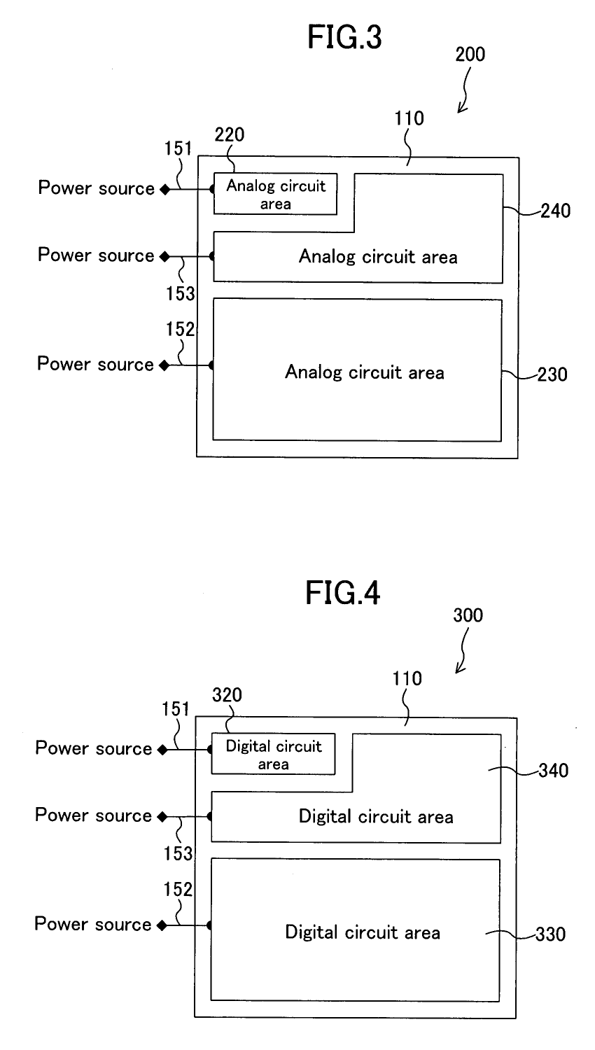

For example, as shown in FIG. 3, a semiconductor integrated circuit 200 includes a semiconductor substrate 110, an analog circuit area 220, an analog circuit area 230, and an analog circuit area 240, and the all circuit areas are thus areas including analog circuits. In the following embodiments and in the modified examples thereof, members functioning in the same manner as those described in the first embodiment and the like are identified by the same reference numerals and the descriptions thereof will be omitted herein.

The analog circuit area 220 (a protected circuit area) is an area including analog circuits. The characteristics of the circuits in the analog circuit area 220 are degraded according to the level of noise contained in a handled signal and the level of noise propagated thereto through the semiconductor substrate. Specific examples of the circuits formed in the analog circuit area 220 include a LNA (low noise amplifier) and a mixer for a tuner, and other noise-sensitive analog circuits.

The analog circuit area 230 (a high noise circuit area) is an area where analog circuits that produce high level noise are formed. The noise produced by the circuits in the analog circuit area 230 is at such a level that the characteristics of the circuits in the analog circuit area 220 are caused to degrade beyond their acceptable limits. Specific examples of the circuits formed in the analog circuit area 230 include a PLL circuit for a tuner and other analog circuits.

The analog circuit area 240 (a low noise circuit area) is an area where analog circuits that produce low level noise are formed. The noise produced by the circuits in the analog circuit area 240 is not at such a level that the characteristics of the circuits in the analog circuit area 220 are caused to degrade beyond their acceptable limits. Specific examples of the circuits formed in the analog circuit area 240 include a filter and a VGA for a tuner and other analog circuits.

It should be noted that as in a semiconductor integrated circuit 300 shown in FIG. 4, all circuit areas may be areas including digital circuits.

The digital circuits in a digital circuit area 320 (a protected circuit area) are noise-sensitive circuits such as high-speed interfaces, for example. The characteristics of the circuits in the digital circuit area 320 are degraded according to the level of propagated noise.

The digital circuits in a digital circuit area 330 (a high noise circuit area) produce noise at a level corresponding to the operating frequency thereof. The noise produced by the digital circuits in the digital circuit area 330 is at such a level that the characteristics of the circuits in the digital circuit area 320 are caused to degrade beyond their acceptable limits.

The circuits in a digital circuit area 340 (a low noise circuit area) also produce noise at a level corresponding to the operating frequency thereof. Since the operating frequency of the circuits in the digital circuit area 340 is lower than that of the circuits in the digital circuit area 330, the level of the noise produced by the circuits in the digital circuit area 340 is at such a level that the characteristics of the circuits in the digital circuit area 320 are caused to degrade only within their acceptable limits.

### Third Embodiment

The number of power sources for supplying power supply voltage to the circuits in each of the protected circuit area, the high noise circuit area, and the low noise circuit area is not limited to the example described above, so long as the power source(s) for supplying power supply voltage to the protected circuit area, the power source(s) for supplying power supply voltage to the low noise circuit area, and the power source(s) for supplying power supply voltage to the high noise circuit area are not connected with each other and are separate from each other.

A semiconductor integrated circuit according to a third embodiment is an example in which the number of power sources for each area such as the protected circuit area is different from that in the first embodiment.

For instance, in the example of a semiconductor integrated circuit 400 shown in FIG. 5, five power sources 451 to 455 are provided, and the number of power sources provided is larger than the number of areas, which is three. These power sources are separate from each other, and no single power source supplies power to multiple areas.

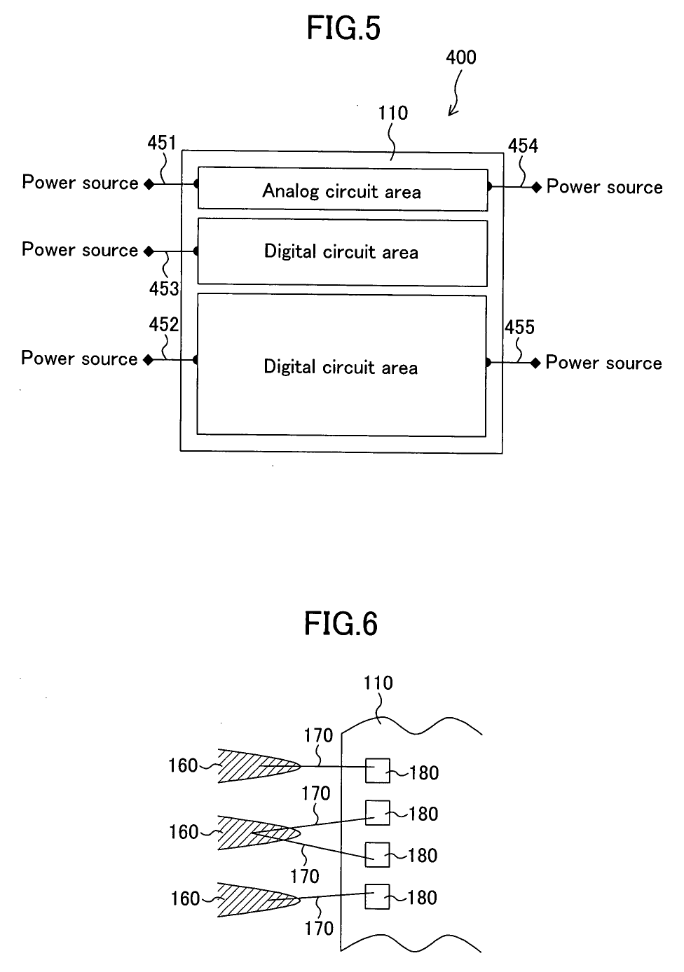

It is sufficient if the power sources are separate from each other on the semiconductor substrate. FIG. 6 is a view illustrating connections between the semiconductor substrate 110 and power terminals.

Lead frames 160 (power terminals) are supplied with power supply voltage from outside the semiconductor integrated circuit.

Bonding wires 170 connect the lead frames 160 and bonding pads 180.

The bonding pads 180 supply the power supply voltage provided through the bonding wires 170 with the circuits in the protected circuit area, high noise circuit area, and low noise circuit area through power wires (not shown).

In this example, as shown in FIG. 6, one of the lead frames 160 is connected with multiple bonding pads 180. Therefore, the power sources are not separate from each other at the product terminals, and the same power terminal supplies the power supply voltage to the multiple areas. However, on the semiconductor substrate 110, the paths for supplying the power to the protected circuit area, to the high noise circuit area, and to the low noise circuit area are separate from each other, which prevents direct propagation of noise through the semiconductor substrate 110.

### Fourth Embodiment

The number of protected circuit areas, the number of high noise circuit areas, and the number of low noise circuit areas are not limited to the numbers and to the physical shapes described above, so long as the protected circuit area(s) and the high noise circuit area(s) are physically separated by the low noise circuit area(s) so as to prevent contact between the protected circuit area(s) and the high noise circuit area(s).

A semiconductor integrated circuit according to a fourth embodiment is an example in which the number and shapes of areas such as the protected circuit area are different from those in the first embodiment.

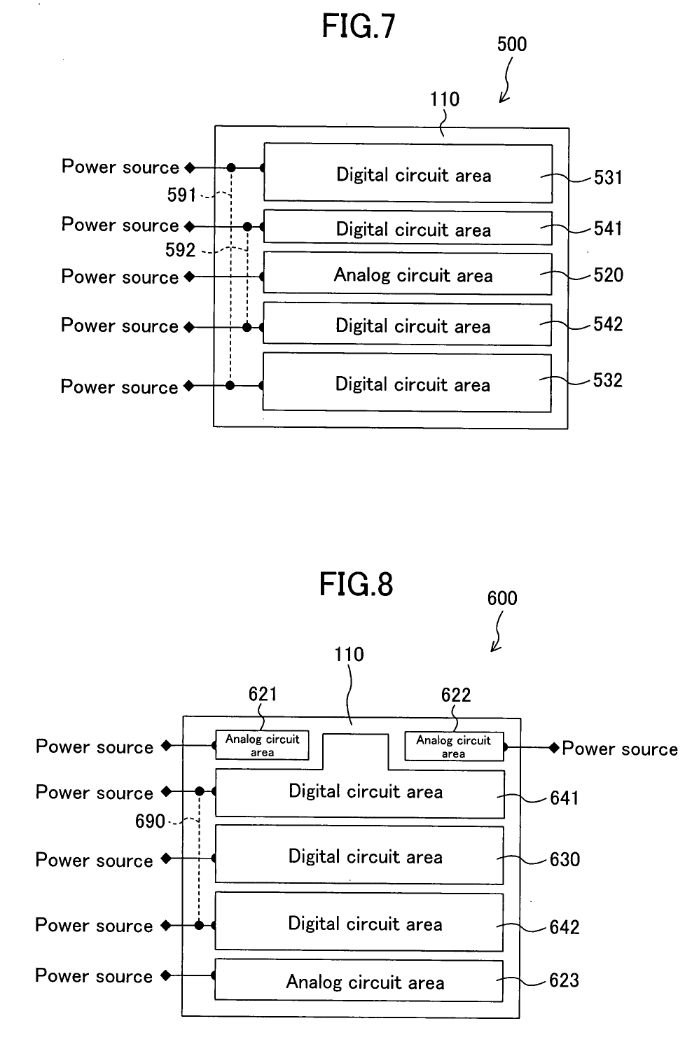

For example, the protected circuit area, the high noise circuit areas, and the low noise circuit areas may be arranged as in a semiconductor integrated circuit 500 shown in FIG. 7. As shown in FIG. 7, the semiconductor integrated circuit 500 includes a semiconductor substrate 110, an analog circuit area 520 (a protected circuit area), digital circuit areas 531 and 532 (high noise circuit areas), and digital circuit areas 541 and 542 (low noise circuit areas).

The analog circuit area 520 is an area including analog circuits. Examples of the circuits in the analog circuit area 520 include a tuner, an AD converter, a DA converter, a PLL circuit, a VCO circuit, a filter, an operational amplifier, and other noise-sensitive analog circuits.

The digital circuit areas 531 and 532 and the digital circuit areas 541 and 542 are areas including digital circuits. In this example, the operating frequencies of the circuits in the digital circuit areas 531, 532, 541 and 542 are expressed by f531, f532, f541, and f542, respectively, and it is assumed that the inequality f541<f542<f531<f532 holds. In this case, when the levels of noise produced by the circuits in the digital circuit areas 531, 532, 541 and 542 are n531, n532, n541, and n542, respectively, the inequality n541<n542<n531<n532 holds. In this exemplary device, when the noise level is n542 or lower, degradation of the characteristics of the circuits in the analog circuit area 520 is within their acceptable limits, but when the noise level is n531 or higher, the characteristics of the circuits in the analog circuit area 520 are degraded beyond their acceptable limits.

The digital circuit area 541 is physically located between the analog circuit area 520 and the digital circuit area 531 so as to prevent contact between the analog circuit area 520 and the digital circuit area 531. The digital circuit area 542 is also physically located between the analog circuit area 520 and the digital circuit area 532 so as to prevent contact between the analog circuit area 520 and the digital circuit area 532.

In the semiconductor integrated circuit 500, power sources for supplying power supply voltage to the above-described respective areas are also separate from each other.

In the semiconductor integrated circuit 500 thus structured, noise produced in the digital circuit areas 531 and 532 does not propagate to the analog circuit area 520 (the protected circuit area) as in the semiconductor integrated circuit 100. Accordingly, in the semiconductor integrated circuit 500, it is also possible to prevent degradation of the characteristics of the circuits in the analog circuit area 520.

In the semiconductor integrated circuit 500, as shown in FIG. 7, the power source for supplying power supply voltage to the digital circuit area 541 and the power source for supplying power supply voltage to the digital circuit area 542 may be connected by a wire 592, and the power source for supplying power supply voltage to the digital circuit area 531 and the power source for supplying power supply voltage to the digital circuit area 532 may be connected by a wire 591. Even if the power sources are connected in this way, the power sources for the high noise circuit areas (the digital circuit areas 531 and 532) and the power sources for the low noise circuit areas (the digital circuit areas 541 and 542) are separate from each other. Thus, noise occurring in the digital circuit areas 531 and 532 (the high noise circuit areas) is absorbed in the digital circuit areas 541 and 542 and does not propagate to the analog circuit area 520.

Also, the protected circuit area, the high noise circuit areas, and the low noise circuit areas may be arranged as in a semiconductor integrated circuit 600 shown in FIG. 8. As shown in FIG. 8, the semiconductor integrated circuit 600 includes a semiconductor substrate 110, analog circuit areas 621 to 623 (protected circuit areas), a digital circuit area 630 (a high noise circuit area), and digital circuit areas 641 and 642 (low noise circuit areas).

The analog circuit areas 621 to 623 are areas including analog circuits. Examples of the circuits in the analog circuit areas 621 to 623 include a tuner, an AD converter, a DA converter, a PLL circuit, a VCO circuit, a filter, an operational amplifier, and other noise-sensitive analog circuits.

The digital circuit area 630 and the digital circuit areas 641 and 642 are areas including digital circuits. In this example, the operating frequencies of the circuits in the digital circuit areas 630, 641 and 642 are expressed by f630, f641, and f642, respectively, and it is assumed that the inequality f642<f641<f630 holds. In this case, when the levels of noise produced by the circuits in the digital circuit areas 630, 641 and 642 are expressed by n630, n641, and n642, respectively, the inequality n642<n641<n630 holds. It is assumed that when the noise level is n641 or lower, degradation of the characteristics of the circuits in the analog circuit areas 621 to 623 is within their acceptable limits, but when the noise level is n630 or higher, the characteristics are degraded beyond their acceptable limits.

As shown in FIG. 8, the digital circuit area 641 is physically located between the analog circuit area 621 and the digital circuit area 630 so as to prevent contact between the analog circuit area 621 and the digital circuit area 630. The digital circuit area 641 is also physically located between the analog circuit area 622 and the digital circuit area 630 so as to prevent contact between the analog circuit area 622 and the digital circuit area 630. The digital circuit area 642 is physically located between the analog circuit area 623 and the digital circuit area 630 so as to prevent contact between the analog circuit area 623 and the digital circuit area 630.

In the semiconductor integrated circuit 600, power sources for supplying power supply voltage to the above-described respective areas are also separate from each other.

In the semiconductor integrated circuit 600 thus structured, noise occurring in the digital circuit area 630 does not propagate to the noise-sensitive analog circuit areas 621 to 623 as in the semiconductor integrated circuit 100. Accordingly, it is possible to suppress degradation of the characteristics of the circuits in the analog circuit areas 621 to 623 (the protected circuit areas).

In the semiconductor integrated circuit 600, the power source for supplying power supply voltage to the digital circuit area 641 and the power source for supplying power supply voltage to the digital circuit area 642 may be connected by a wire 690 as shown in FIG. 8. Even if the power sources are connected in this way, the power source for the high noise circuit area (the digital circuit area 630) and the power sources for the low noise circuit areas (the digital circuit areas 641 and 642) are separate from each other. Thus, noise occurring in the digital circuit area 630 (the high noise circuit area) is absorbed in the digital circuit areas 641 and 642 and does not propagate to the analog circuit areas 621 to 623.

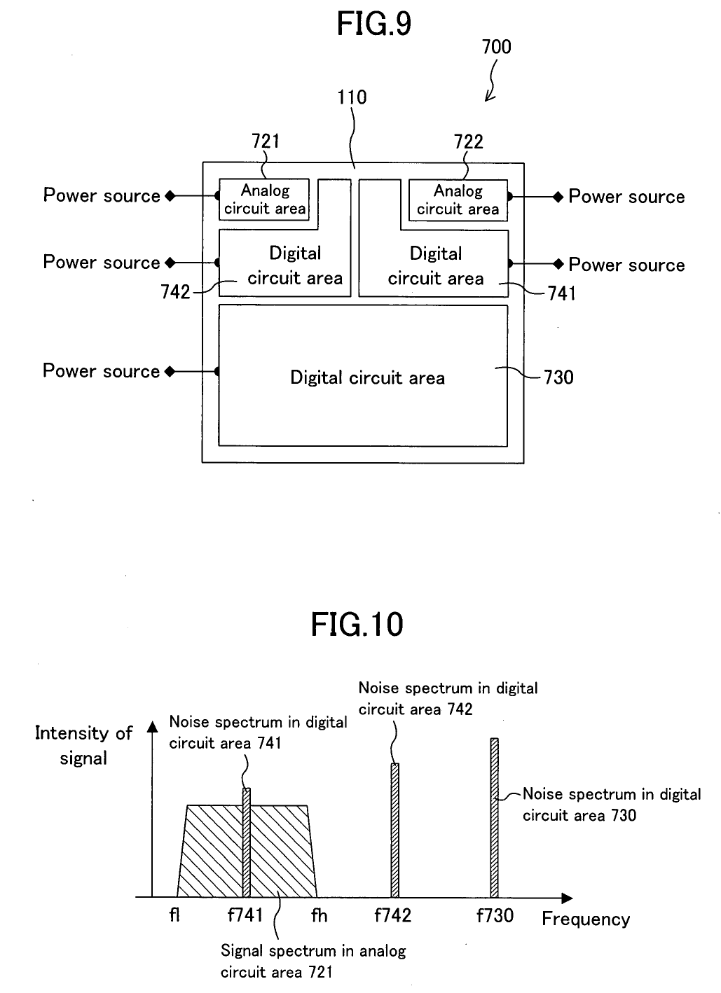

Furthermore, the protected circuit areas, the high noise circuit area, and the low noise circuit areas may be arranged as in a semiconductor integrated circuit 700 shown in FIG. 9. As shown in FIG. 9, the semiconductor integrated circuit 700 includes a semiconductor substrate 110, analog circuit areas 721 and 722 (protected circuit areas), a digital circuit area 730 (a high noise circuit area), and digital circuit areas 741 and 742 (low noise circuit areas).

The analog circuit areas 721 and 722 are areas including analog circuits. Examples of the circuits in the analog circuit areas 721 and 722 include a tuner, an AD converter, a DA converter, a PLL circuit, a VCO circuit, a filter, an operational amplifier, and other noise-sensitive analog circuits.

The digital circuit areas 730, 741, and 742 are areas including digital circuits. In this example, the operating frequencies of the circuits in the digital circuit areas 730, 741 and 742 are expressed by f730, f741, and f742, respectively, and it is assumed that the inequality f741<f742<f730 holds. In this case, when the levels of noise produced by the circuits in the digital circuit areas 730, 741 and 742 are expressed by n730, n741, and n742, respectively, the inequality n741<n742<n730 holds.

It is also assumed that the lower and upper limit frequencies of the frequency band of signals handled in the analog circuit area 721 are fl and fh, respectively, and that the inequality fl<f741<fh<f742<f730 holds.

As shown in FIG. 9, the analog circuit area 721 is located so as not to be in contact with the digital circuit area 741. The digital circuit area 741 is physically located between the analog circuit area 722 and the digital circuit area 730 so as to prevent contact between the analog circuit area 722 and the digital circuit area 730. The digital circuit area 742 is physically located between the analog circuit area 721 and the digital circuit area 730 so as to prevent contact between the analog circuit area 721 and the digital circuit area 730.

The reason why the analog circuit area 721 and the digital circuit area 741 are provided so as not to be in contact with each other as described above is because the operating frequency of the circuits in the digital circuit area 741 is within the frequency band of signals handled in the analog circuit area 721, and noise produced by these circuits thus presumably becomes a direct noise component, although their operating frequency is low and the level of the noise is thus low.

In the semiconductor integrated circuit 700, power sources for supplying power supply voltage to the above-described respective areas are also separate from each other.

FIG. 10 shows spectral distributions of noise produced in the digital circuit areas 730, 741 and 742 and a spectral distribution of signals handled in the analog circuit area 721. As can be seen from FIG. 10, if the noise produced in the digital circuit areas 730, 741 and 742 is propagated to the analog circuit area 721, the noise produced in the digital circuit area 741 overlaps the signal band (from fl to fh) handled in the analog circuit area 721 and thus becomes direct noise.

Therefore, in order to prevent the noise produced in the digital circuit area 741 from propagating to the analog circuit area 721, the analog circuit area 721 and the digital circuit area 741 are located so as not to be in contact with each other.

Accordingly, the high-level noise produced in the digital circuit area 730 does not propagate to the noise-sensitive analog circuit areas 721 and 722, and the noise produced in the digital circuit area 741 does not propagate to the analog circuit area 721.

Consequently, in the semiconductor integrated circuit 700, it is also possible to suppress degradation of the characteristics of the circuits in the protected circuit areas.

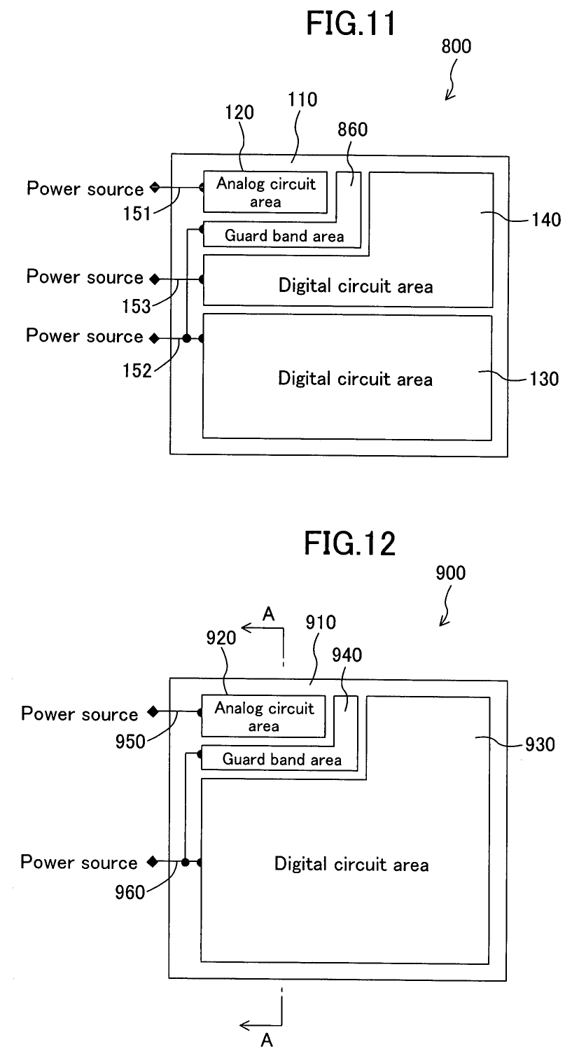

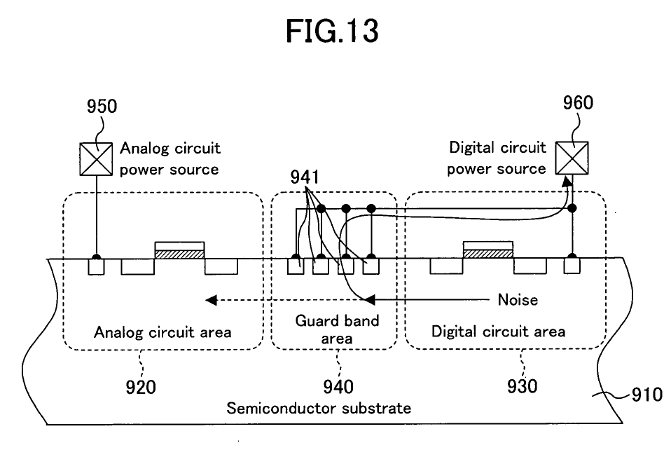

It should be noted that as in a semiconductor integrated circuit 800 shown in FIG. 11, a guard band area 860 may be additionally provided between the analog circuit area 120 and the digital circuit area 140 in the semiconductor integrated circuit 100. The guard band area 860 is the same as the guard band area provided in the conventional semiconductor integrated circuit. The addition of the guard band area 860 enables degradation of the characteristics of the circuits in the protected circuit area to be prevented more effectively.

It should be also noted that the circuits formed in the low noise circuit areas are not limited to those analog circuits and digital circuits exemplified above.

Moreover, as the examples of the circuits formed in the high noise circuit areas, the digital circuits that operate at high frequencies have been described. However, the circuits formed in the high noise circuit areas may be any circuits that produce noise causing degradation of the characteristics of the circuits in the protected circuit areas, such as VCOs and other analog circuits that produce high frequencies, and circuits that operate at low frequencies but have high peak current, for example.

Furthermore, the circuits formed in the low noise circuit areas are not limited to digital circuits that operate at low frequencies, but may be any circuits, such as circuits having low peak-current, that produce noise at such a level that the characteristics of the circuits in the protected circuit areas are not caused to degrade.

### INDUSTRIAL APPLICABILITY

The semiconductor integrated circuits according to the present invention produce the effect that degradation of the characteristics of circuits due to noise is prevented without increasing the area of the semiconductor integrated circuit. The inventive semiconductor integrated circuits are thus applicable, for example, to semiconductor integrated circuits in which circuits whose characteristics are degraded due to noise and circuits that produce the noise are both included.

1. A semiconductor integrated circuit comprising:
a protected circuit area including circuits whose characteristics are degraded according to the level of noise;
a high noise circuit area including circuits that produce noise at such a level that an amount of degradation caused in the circuits in the protected circuit area due to the noise exceeds an acceptable amount of degradation for the circuits in the protected circuit area;
a low noise circuit area including circuits that produce noise at such a level that an amount of degradation caused in the circuits in the protected circuit area due to the noise is within the acceptable amount of degradation for the circuits in the protected circuit area; and
three or more separate power sources whose paths for supplying power supply voltage are separate from each other,
wherein the low noise circuit area is located between the protected circuit area and the high noise circuit area so as to prevent contact between the protected circuit area and the high noise circuit area; and
the circuits in the protected circuit area, the circuits in the high noise circuit area, and the circuits in the low noise circuit area are supplied with power supply voltage by different power sources of the three or more separate power sources.

2. The semiconductor integrated circuit of claim 1, wherein the circuits in the high noise circuit area and the circuits in the low noise circuit area produce noise at levels corresponding to the levels of the frequencies of signals handled by these circuits, and
the maximum frequency of the signals handled in the low noise circuit area is lower than the frequencies of the signals handled in the high noise circuit area.

3. The semiconductor integrated circuit of claim 1, wherein the circuits in the protected circuit area are analog circuits, and
the circuits in the high noise circuit area are digital circuits.

4. The semiconductor integrated circuit of claim 2, wherein the circuits in the protected circuit area are analog circuits, and
the circuits in the high noise circuit area are digital circuits.
